(19) United States
(12) Patent Application Publication
(10) Pub. No.: US 2012/0069027 A1
(43) Pub. Date: Mar. 22, 2012

(54) INPUT DEVICE

(76) Inventors: Wataru Yamazaki, Tokyo (JP); Reiko Okada, Tokyo (JP); Takahisa Aoyagi, Tokyo (JP)

(21) Appl. No.: 13/148,761

(22) PCT Filed: Apr. 1, 2010
(86) PCT No.: PCT/JP2010/002409

§ 371 Date: Aug. 10, 2011

(30) Foreign Application Priority Data
Apr. 28, 2009 (JP) 2009-109258

(51) Int. Cl. G09G 5/26; G06T 11/00; G06F 3/041

(52) U.S. Cl. 345/472.3; 345/173; 345/467

(57) ABSTRACT

An input device including: a storage unit 6 which stores partial touch area definition data that defines a partial area of a touch input area 2a of a touch-type input device 2 corresponding to an input button displayed on an input screen of a display device 3 as a location on the touch input area 2a; and a storage unit 5 which stores correspondence data in which pattern candidates targeted for pattern recognition selected according to the display contents of the input button are registered by associating with a partial area corresponding to the input button, wherein reference is made to the partial touch area definition data of the storage unit 6 to specify a partial area containing the input starting location of a locus that is input by touching the touch input area 2a of the touch-type input device 2, reference is made to the correspondence data of the storage unit 5 to acquire pattern candidates associated with the specified partial area, and a pattern corresponding to the locus is recognized by using the acquired pattern candidates.

### TECHNICAL FIELD

The present invention relates to an input device in which input of information is carried out by a touch operation.

### BACKGROUND ART

In recent years, devices employing a touch panel without a keyboard have widespread, and have also come to be used in devices having a small screen and small touch area. Examples of character input methods that use a touch panel on a small screen include button input methods that assign a plurality of characters to a small number of buttons, and handwriting recognition methods that recognize characters handwritten with a pen or a finger.

For example, Patent Document 1 discloses a conventional input device that uses an input method that recognizes handwritten characters. The input device of Patent Document 1 sorts a plurality of strokes occurring continuously during the course of writing characters into character units by using a virtual frame that is updated automatically based on an inclusion relationship between a rectangle circumscribing a character stroke and a rectangle of the virtual frame. As a result of this, a user of the device is able to recognize and input a plurality of characters written in any desired character dimensions and any desired location. Like this, Patent Document 1 proposes a method for separating strokes in order to increase the recognition rate of input of characters composed of a plurality of strokes in the manner of Japanese characters.

In addition, a handwritten input device disclosed in Patent Document 2 is provided with a handwritten input tablet and an AIUEO alphabet keyboard, consonants of Romanized kana are input by handwriting with the input tablet, while vowels of Romanized kana are input with a keyboard. Like this, Patent Document 2 proposes a method in which the targets of handwritten character recognition consist of vowels only, while consonants are selected with buttons on a keyboard.

Moreover, Patent Document 3 discloses a touch-type input device having a group of input keys (buttons) arranged in the form of a matrix. In the device, the group of input keys arranged in the form of a matrix is stored in a data table as registration key patterns corresponding to each character, and the identity of a handwritten character is determined based on the results of comparing a handwritten input pattern for the input key group with the registration key patterns.

### PRIOR ART DOCUMENTS

### Patent Documents

Patent Document 1: Japanese Patent Application Laid-open No. H9-161011
Patent Document 2: Japanese Patent Application Laid-open No. S60-136868
Patent Document 3: Japanese Patent Application Laid-open No. 2002-133369

### SUMMARY OF THE INVENTION

Button input methods that assign a plurality of characters to a small number of buttons require an operation to select the characters assigned to the buttons. For example, a list of characters assigned to a button are displayed in response to depression of that button, and a character in the list is then selected by further pressing the button. Thus, in button input methods, since a desired character is input by carrying out an operation for displaying a list of characters assigned to a button and an operation for selecting a character from the list, these methods require the bothersome operation of having to press the same button a plurality of times.

In addition, in handwriting recognition methods that recognize handwritten characters, there is a problem such that as the numbers of characters and patterns to be recognized increase, the recognition rate and recognition speed thereof decrease.

For example, although a plurality of strokes resulting from character input are sorted into character units in Patent Document 1, since it is necessary to carry out recognition from the strokes for each input character, recognition rate and recognition speed decrease if the number of characters to be recognized becomes large.

On the other hand, although only vowels of Romanized kana are targeted for recognition in Patent Document 2, handwritten character input and key (button) input has to be used in combination, thereby requiring the bothersome operation of alternately carrying out different input methods.

Moreover, since handwritten characters are recognized by comparing with registration key patterns corresponding to each character in the method of Patent Document 3, there is the disadvantage of not recognizing a character even if input correctly unless input is carried out that matches a registration key pattern. In addition, in the case of applying to the Japanese language and the like, since the number of registration key patterns of the input key group increase and the targets of comparison also increase in comparison with letters of the alphabet, there is the possibility of a decrease in recognition speed.

The present invention has been made to solve the above-mentioned problems, and an object of the invention is to obtain an input device capable of improving the recognition rate and recognition speed of handwritten character recognition in an input device that uses a touch operation for character input.

The input device according to the invention is provided with a touch-type input unit that inputs a locus obtained by touching a touch input area, a display unit that displays an input screen corresponding to the touch input area of the touch-type input unit, a first storage unit that stores partial area definition data that defines a partial area of the touch input area of the touch-type input unit corresponding to an input button displayed on the input screen of the display unit as a location on the touch input area, a second storage unit that stores correspondence data in which pattern candidates targeted for pattern recognition selected according to display contents of the input button are registered by associating with a partial area corresponding to the input button, and a recognition processing unit that makes reference to the partial area definition data of the first storage unit to specify a partial area containing an input starting location of the locus input to the touch input area of the touch-type input unit, refers to the correspondence data of the second storage unit to acquire pattern candidates associated with the specified partial area, and recognizes a pattern candidate corresponding to the locus using the acquired pattern candidates.

According to this invention, a partial area containing an input starting location of a locus that is input by touching a touch input area of a touch-type input unit is specified by making reference to the partial area definition data, pattern candidates associated with the specific partial area are acquired by making reference to the correspondence data in which pattern candidates targeted for pattern recognition selected according to the display contents of the input button are registered in association with a partial area corresponding to the input button, and a pattern candidate corresponding to the locus is recognized using the acquired pattern candidates. With such a manner, there is provided an effect that enables to improve the recognition rate and recognition speed of handwritten character recognition in an input device that uses a touch operation for character input.

### BRIEF DESCRIPTION OF THE DRAWINGS

FIG. 1 is a block diagram showing the configuration of an input device according to Embodiment 1 of the present invention.

FIG. 2 is a drawing showing an example of partial touch area/input feature pattern correspondence data.

FIG. 3 is a drawing showing a typical application example of an input device according to Embodiment 1.

FIG. 4 is a flow chart showing the flow of an operation by the pattern recognition processing unit shown in FIG. 1.

FIG. 5 is a drawing showing another application example of an input device according to Embodiment 1.

FIG. 6 is a drawing showing another application example of a input device according to Embodiment 1.

FIG. 7 is a drawing showing an example of registration processing of patterns used in character recognition.

FIG. 8 is a drawing showing normalization processing of a handwritten input locus.

FIG. 9 is a flowchart showing the flow of operation by a pattern recognition processing unit according to Embodiment 2 of the invention.

FIG. 10 is a drawing for explaining an example of weighting.

FIG. 11 is a block diagram showing the configuration of an input device according to Embodiment 3 of the invention.

FIG. 12 is a drawing showing an application example of an input device according to Embodiment 3.

FIG. 13 is a block diagram showing the configuration of an input device according to Embodiment 4 of the invention.

FIG. 14 is a drawing for explaining processing for enlarging the display of a partial touch area in proximity to an area approached by an object.

FIG. 15 is a drawing showing an application example of an input device according to Embodiment 3.

### BEST MODE FOR CARRYING OUT THE INVENTION

The following provides an explanation of embodiments of the present invention in accordance with the appended drawings for the purpose of providing a more detailed explanation of the invention.

### Embodiment 1

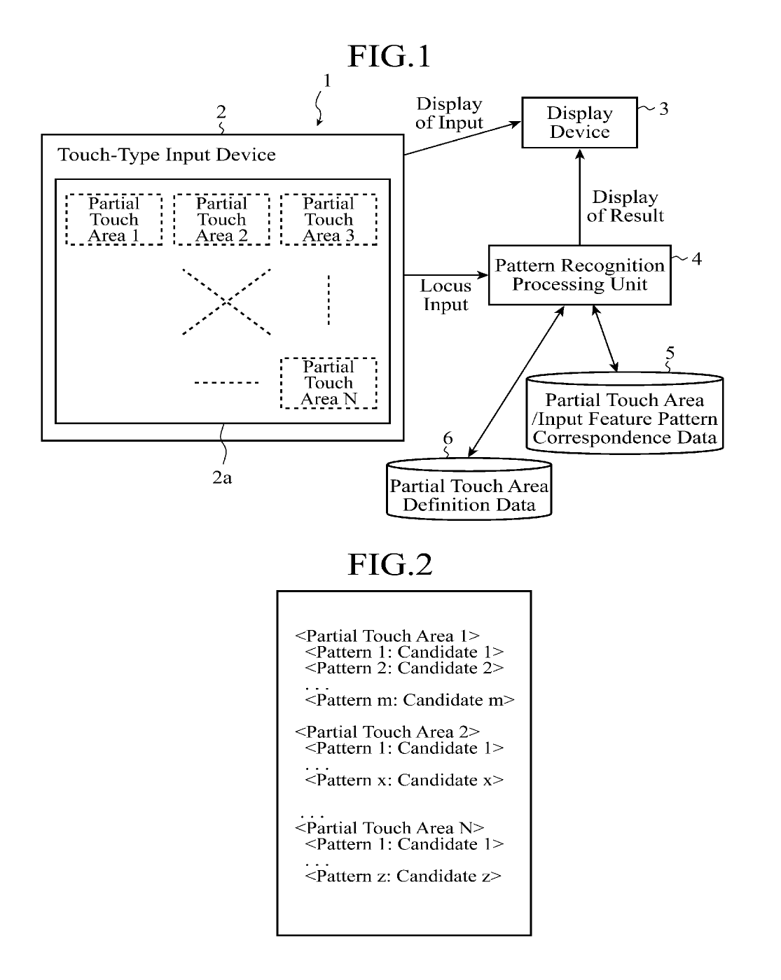

FIG. 1 is a block diagram showing the configuration of an input device according to Embodiment 1 of the present invention. In FIG. 1, an input device 1 according to Embodiment 1 is provided with a touch-type input device (touch-type input unit) 2, a display device (display unit) 3, a pattern recognition processing unit (recognition processing unit) 4, a storage unit (second storage unit) 5 for partial touch area/input feature pattern correspondence data (correspondence data), and a storage unit (first storage unit) 6 for partial touch area definition data (partial area definition data).

The touch-type input device 2 is provided with a function that acquires a locus according to a manual input or pen input of a user to a touch input area 2a. A touch pad used in a personal computer (PC), for example, is an example of the touch-type input device 2. Furthermore, the touch-type input device 2 may also be a touch panel integrated with the display device 3.

The display device 3 is a constituent that displays input feedback (for example, a locus display) from the touch-type input device 2, or input contents of a user predicted with the pattern recognition processing unit 4. The pattern recognition processing unit 4 is a constituent that detects a partial touch area of the touch input area 2a from the locus input obtained with the touch-type input device 2 using partial touch area definition data, acquires an input feature pattern associated with the partial touch area, and predicts the intended input contents of a user from the locus input.

The storage unit 5 is a storage unit that stores partial touch area/input feature pattern correspondence data. Partial touch area/input feature pattern correspondence data refers to data composed by registering feature patterns that are candidates of handwritten input for each partial touch area defined by partial touch area definition data. Furthermore, a feature pattern is the amount of features for a character candidate.

The storage unit 6 is a storage unit that stores partial touch area definition data. Partial touch area definition data refers to data composed by registering data that defines each of a plurality of partial touch areas obtained by dividing the touch input area 2a of the touch-type input device 2. Partial touch areas are defined as follows: for example, a rectangle composed of points (x1,y1) and points (x2,y2) on the touch input area 2a can be defined as a partial area A in the following formula (1).

<Rectangle (x1,y1,x2,y2): Partial area A> (1)

FIG. 2 is a drawing showing one example of partial touch area/input feature pattern correspondence data. In the example of FIG. 2, the partial touch area/input feature pattern correspondence data is composed of data corresponding to each of n number of partial touch areas. Hereupon, there are m number of patterns associated with partial touch area 1 consisting of pattern 1 to pattern m, there are x number of patterns associated with partial touch area 2 consisting of pattern 1 to pattern x, and there are z number of patterns associated with partial touch area n consisting of pattern 1 to pattern z.

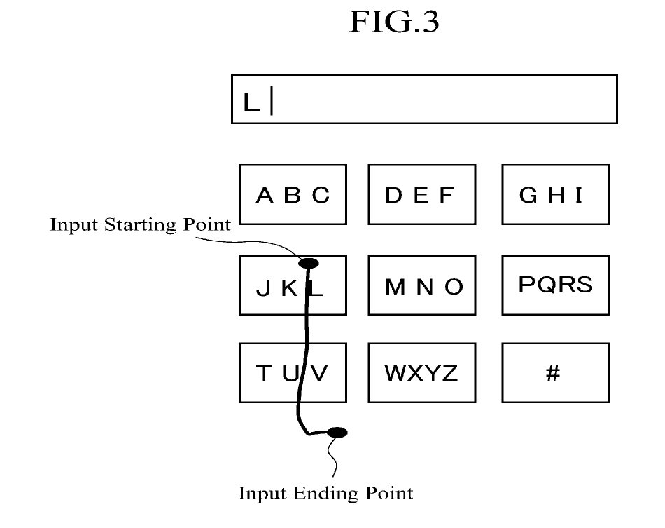

FIG. 3 is a drawing showing a typical application example of an input device according to Embodiment 1, and indicates the case of applying the invention to a touch panel in which nine buttons are arranged starting with a button “ABC” to a button “#”. Hereupon, the area of each button is a partial touch area, and the letters A to Z and the symbol # are registered as patterns.

For example, three patterns consisting of pattern 1 for A, pattern 2 for B and pattern 3 for C are defined as character candidates of a handwritten input for the button “ABC”. Also, three patterns consisting of pattern 1 for J, pattern 2 for K and pattern 3 for L are defined as character candidates of a handwritten input for a button “JKL”, while four patterns consisting of pattern 1 for P, pattern 2 for Q, pattern 3 for R and pattern 4 for S are defined as character candidates of a handwritten input for a button “PQRS”.

When a handwritten input of a user is started on the button “JKL”, the three letters of J, K and L are specified as letter candidates from the partial touch area/input feature pattern correspondence data of the button “JKL”. In the example shown in FIG. 3, according to the handwritten input of the user, an approximately linear locus continues downward from an input starting point and then turns to the right to reach the location of an input ending point. The resultant locus approximates the letter “L” among the letter candidates of button “JKL”, and thereby the “L” is recognized as the intended input letter of the user.

In Embodiment 1, a letter candidate used as a pattern is correlated for each button serving as a partial touch area and is registered as partial touch area/input feature pattern correspondence data, and during handwritten input, only the pattern candidate corresponding to the button at the location where input is started is extracted, and a letter intended by a user is recognized among pattern candidates based on the subsequent input locus.

Thus, when pattern candidates are narrowed down, the improvement of the recognition speed can be intended; recognition errors can also be reduced since the most probable candidate is recognized among the restricted candidates.

Next, an operation thereof will be described.

Hereupon, an explanation is given of the detailed operation of the pattern recognition processing unit 4 that carries out the aforementioned recognition processing.

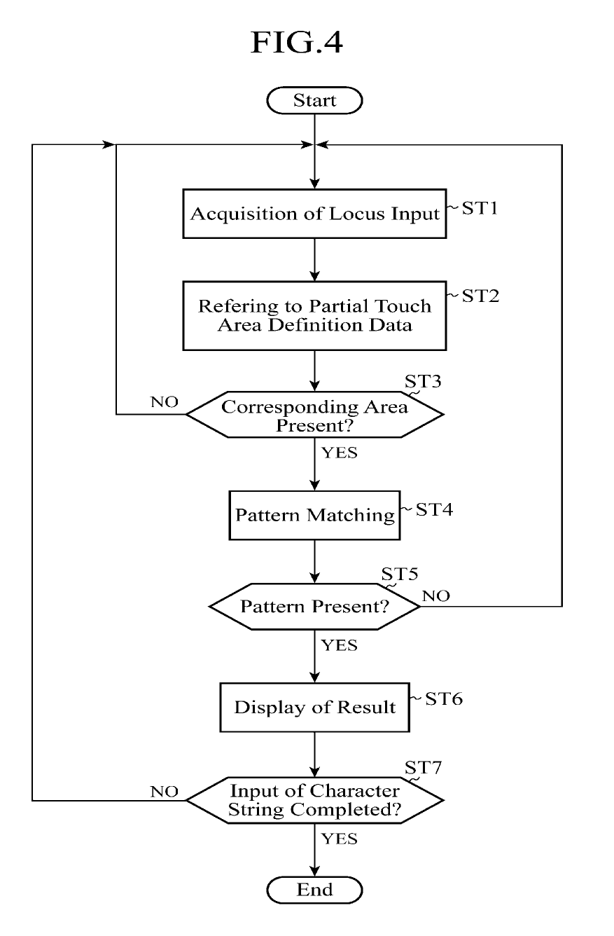

FIG. 4 is a flow chart showing the flow of an operation by the pattern recognition processing unit 4 in FIG. 1.

First, a user carries out a handwritten input by a touch operation on the touch input area 2a of the touch-type input device 2. The data of a locus resulting from the handwritten input is acquired by the touch-type input device 2 and transferred to the pattern recognition processing unit 4 as the input of the locus.

In the pattern recognition processing unit 4, when a locus input is acquired from the touch-type input device 2 (Step ST1), reference is made to partial touch area definition data of the storage unit 6 based on position coordinates of the input starting point of the locus (Step ST2), and the presence or absence of a partial touch area corresponding to the locus is determined (Step ST3). In the case where there is no corresponding partial touch area (NO in Step ST3), the pattern recognition processing unit 4 returns to the processing of Step ST1, and either instructs re-input or acquires a locus input relating to the next character of the character string to be input.

On the other hand, in the case where there is a corresponding partial touch area (YES in Step ST3), the pattern recognition processing unit 4 searches the storage unit 5 based on the partial touch area, refers to the corresponding partial touch area/input feature pattern correspondence data, and executes pattern matching between patterns registered for the data and the locus input acquired in Step ST1 (Step ST4), and determines whether or not there is a corresponding pattern (Step ST5). At this stage, in the case where there is no corresponding pattern (NO in Step ST5), the pattern recognition processing unit 4 returns to the processing of Step ST1.

In addition, in the case where there is a corresponding pattern in the partial touch area/input feature pattern correspondence data (YES in Step S5), the pattern recognition processing unit 4 outputs the pattern to the display device 3 as a recognition result. As a result, the pattern of the recognition result is displayed on the display screen of the display device 3 (Step ST6).

Subsequently, the pattern recognition processing unit 4 determines whether or not input of character strings by the current handwritten input has been completed until data specifying completion of input is acquired from the touch-type input device 2 (Step ST7). At this stage, if character string input has not been completed (NO in Step ST7), the pattern recognition processing unit 4 returns to the processing of Step ST1 and repeats the processing described above on the next input character. Alternatively, processing ends if character string input has been completed (YES in Step ST7).

A specific explanation will now be given of the above-mentioned with reference to the example shown in FIG. 3.

The pattern recognition processing unit 4 acquires locus data from the input starting point on button “JKL” to the input ending point as locus input from the touch-type input device 2. Next, the pattern recognition processing unit 4 makes reference to partial touch area definition data of the storage unit 6 and specifies partial touch area definition data indicating button “JKL” based on the position coordinates of the input starting point in the locus data.

Subsequently, the pattern recognition processing unit 4 searches the storage unit 5 for data that identifies such partial touch area (designated as “area J”), and extracts the three characters of “J”, “K” and “L” associated with area J as a character recognition target pattern from partial touch area/input feature pattern correspondence data relating to area J.

Subsequently, the pattern recognition processing unit 4 respectively carries out pattern matching between the locus pattern acquired from the touch-type input device 2 and the patterns of the three characters targeted for character recognition. In this case, since the locus continues downward with an approximately straight line from the input starting point and then turns to the right to reach the location of the input ending point, the pattern recognition processing unit 4 selects an “L” as the letter having the most closely matching pattern among these three patterns, and determines it to be the intended input letter of the user. As a result, an “L” is displayed in the display column of the recognized letter on the display screen of the display device 3 as shown in FIG. 3.

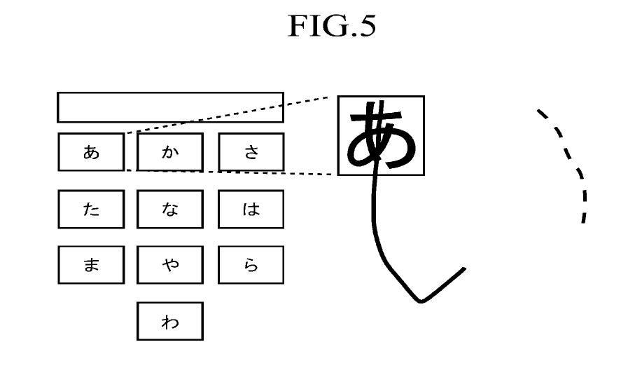

FIG. 5 is a drawing showing another application example of an input device according to Embodiment 1, and indicates the case of applying the present invention to a touch panel on which are arranged nine (ten) buttons containing the Japanese vowels of “ [symbol] ” (a), “ [symbol] ” (ka), “ [symbol] ” (sa), “ [symbol] ” (ta), “ [symbol] ” (na), “ [symbol] ” (ha), “ [symbol] ” (ma), “ [symbol] ” (ya), “ [symbol] ” (ra) and “ [symbol] ” (wa). In FIG. 5, the nine (ten) button areas are each partial touch areas, and handwritten input kana characters are recognized.

In the case where an input character is constituted by a plurality of strokes like the Japanese language, matching may be carried out each time one stroke is input, and the input character may be discriminated before all strokes have been input. In this case, a configuration may be employed in which discrimination is carried out for the next stroke if the difference between matching scores with a plurality of pattern candidates for each stroke does not exceed a prescribed threshold value.

Pattern discrimination for characters composed of a plurality of strokes is carried out using the processing flow described below.

First, as initialization processing, the pattern recognition processing unit 4 initializes a score retention matrix score (p) (s) (p: the number of recognition targets, s: the maximum number of strokes) to zero (p=0, s=0). Then, as score calculation processing, the pattern recognition processing unit 4 respectively calculates the score retention matrix score (p) (s) of the s-th stroke of each recognition pattern p (0≦p<X; where, p is an integer).

Next, as score total calculation processing, the pattern recognition processing unit 4 calculates the sum (p, s) of the scores to the s-th stroke of each recognition target number p. Subsequently, the pattern recognition processing unit 4 compares the sum (p, s) having the largest score with the sum (p, s) having the second largest score, and if the difference exceeds a threshold value d, selects the pattern having the larger score to complete processing. On the other hand, if the difference is equal to or less than the threshold value d, 1 is added to the value of s, the pattern recognition processing unit 4 returns to score calculation processing and repeats the above-mentioned processing.

For example, in the case where “ [symbol] ” (a), “ [symbol] ” (i), “ [symbol] ” (u), “ [symbol] ” (e) and “ [symbol] ” (o) are pattern candidates of a character recognition target in a partial touch area corresponding to a button “ [symbol] ” (a), if the first stroke for which input has been started on the “ [symbol] ” (a) button is an input locus as shown in FIG. 5, pattern matching is carried out between the locus of the stroke and the above-mentioned pattern candidates, and the character “ [symbol] ” (i) is determined to be the recognition result since the difference in matching scores with the stroke among these pattern candidates is equal to or less than a threshold value. At this time, since the character has been recognized without having to input the second stroke of the character “ [symbol] ” (i), the second stroke is displayed, for example, as indicated with the broken line of FIG. 5. Additionally, the contrast of the second stroke may also be displayed to be different from that of the first stroke in order to indicate that this is the second stroke estimated according to the recognition result. For example, the second stroke may be displayed using a lighter color.

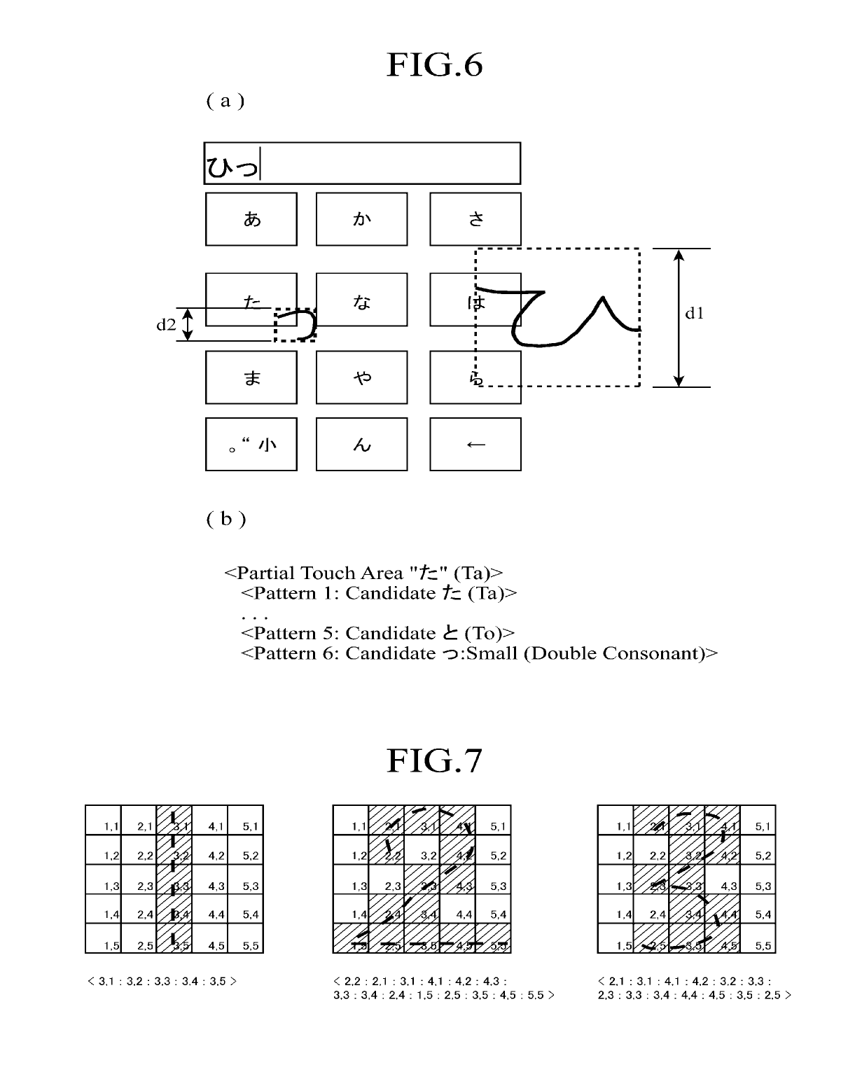

FIG. 6 is a drawing showing another application example of the input device according to Embodiment 1, and indicates the case of applying the present invention to a touch panel on which are arranged 12 buttons consisting of “ [symbol] ” (a), “ [symbol] ” (ka), “ [symbol] ” (sa), “ [symbol] ” (ta), “ [symbol] ” (na), “ [symbol] ” (ha), “ [symbol] ” (ma), “ [symbol] ” (ya), “ [symbol] ” (ra), “∘ “ [symbol] ” (period (lower)), “ [symbol] (n) and “←”. In FIG. 6(a), the 12 button areas each are partial touch areas, and handwritten input kana characters are recognized. Specifically, FIG. 6(b) indicates partial touch area/input feature pattern correspondence data for the partial touch area “ [symbol] ” (ta) of button “ [symbol] ” (ta).

The following case is taken as an example: in the partial touch area of button “ [symbol] ” (ha), pattern candidates of the character recognition target consist of “ [symbol] ” (ha), “ [symbol] ” (hi), “ [symbol] ” (fu), “ [symbol] ”” (he) and “ [symbol] ” (ho), while in the partial touch area of button “ [symbol] ” (ta), pattern candidates of the character recognition target consist of “ [symbol] ” (ta), “ [symbol] ” (chi), “ [symbol] (te), [symbol] ” (to), “ [symbol] ” (tsu) and the lower case “ [symbol] ” (double consonant), as shown in FIG. 6(b).

In this case, as shown in FIG. 6(a), in the case a locus having an input starting point on button “ [symbol] ” (ha) is recognized as the character “ [symbol] ” (hi), after which the locus having an input starting point on button “ [symbol] ” (ta) is recognized as the character “ [symbol] ” (tsu), it is compared with the size of the character “ [symbol] ” (hi) recognized prior to the character, and may be determined to be either the upper case “ [symbol] ” (tsu) or the lower case “ [symbol] ” (double consonant).

In the example of FIG. 6(a), in the case of defining the length of one side of a square inscribing the locus recognized as the character “ [symbol] ” (hi) as d1, and defining the length of one side of a square inscribing the locus able to be recognized as the upper case “ [symbol] ” (tsu) or the lower case “ [symbol] ” (double consonant) as d2, the pattern recognition processing unit 4 compares d1 and d2, and if d1>d2 and the difference thereof exceeds a prescribed threshold value, the character is ultimately recognized to be the lower case “ [symbol] ” (double consonant). More specifically, the pattern candidate “ [symbol] ” (tsu), to which the flag “small” indicating a lower case character has been imparted, is determined to be the recognition result among the partial touch area/input feature correspondence data for the partial touch area “ [symbol] ” (ta) indicated in FIG. 6(b).

The following provides an explanation of character recognition by the pattern recognition processing unit 4 (processing of Steps ST4 and ST5 in FIG. 4).

FIG. 7 is a drawing showing an example of pattern registration processing used in character recognition, and indicates the case of recognizing the numbers 1, 2 and 3. The example shown in FIG. 7 indicates the case of registering patterns corresponding to recognition in an N×N (here, 5×5) area as a sequence of ordered points. Furthermore, recognition patterns are registered in a recognition library not shown in FIG. 1. The recognition library is stored in a memory which is properly readable by the pattern recognition processing unit 4 by the pattern recognition processing unit 4.

By specifying each area as a matrix (x, y), the recognition pattern of the number “1”, for example, is registered as pattern <3,1:3,2:3,3:3,4:3,5>. In addition, the recognition pattern of the number “2” is registered as pattern <2,2:2,1:3,1:4,1:4,2:4,3:3,3:3,4:2,4:1,5:2,5:3,5:4,5:5:5>, while the recognition pattern of the number “3” is registered as pattern <2,1:3,1:4,1:4,2:3,2:3,3:2,3:3,3:3,4:4,4:4,5:3,5:2,5>.

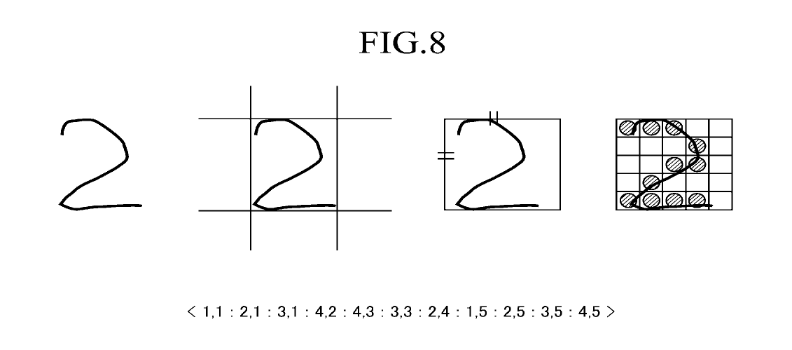

FIG. 8 is a drawing showing normalization processing of a handwritten input locus. When the pattern recognition processing unit 4 acquires a locus input from the touch input area 2a, the pattern recognition processing unit 4 detects position coordinates of four corners of a rectangle that inscribes the input locus, and converts (normalizes) the rectangle to the (5×5) square area of the recognition pattern. As a result, as shown in FIG. 8, the handwritten input number “2” is converted to the pattern <1,1:2,1:3,1:4,2:4,3:3,3:2,4:1,5:2,5:3,5:4,5>.

Thereafter, the pattern recognition processing unit 4 calculates the distance between a (5×5) recognition pattern read from the recognition library and the handwritten input locus normalized to a (5×5) matrix. For example, the distance between patterns having different lengths is determined by extending the shorter pattern and calculating the distance at each point. The pattern recognition processing unit 4 then carries out the above-mentioned distance calculation for all recognition patterns registered in the recognition library, and determines the pattern having the shortest distance to be pattern of the recognition result.

Furthermore, the invention is not limited to the character recognition algorithm described above, and is not dependent on the type of character recognition algorithm.

As described above, according to Embodiment 1, by making reference to partial touch area definition data that defines a partial touch area of the touch input area 2a of the touch-type input device 2 corresponding to an input button displayed on an input screen of the display device 3 as a location on the touch input area 2a, specifying a partial touch area that includes the input starting location of a locus that is input by touching the touch input area 2a of the touch-type input device 2; by making reference to correspondence data in which pattern candidates targeted for pattern recognition selected according to the display contents of the input button are registered in association with a partial area corresponding to the input button, pattern candidates associated with the specified partial area are acquired, thereby recognizing the pattern corresponding to the locus by using the acquired pattern candidates. With this manner, the recognition rate and recognition speed of handwritten character input is improved since the number of characters serving as pattern candidates can be narrowed down.

For example, in the case the letters “ABC” are displayed, and manual input is started on a key button for which the recognition pattern candidates to be used in character recognition consist of “A”, “B” and “C”, then the character recognition targets are limited to only the three characters of “A”, “B” and “C” set for the corresponding key button in order to recognize the manually input character.

In addition, according to the above Embodiment 1, in recognizing characters or gestures composed of a plurality of strokes, the pattern candidate that includes the first stroke and demonstrates the closest match among the pattern candidates set for the partial touch area where input of the first stroke is started is determined to be the recognition result. As a result, by reducing the number of recognition targets according to the location where input was started, the recognition target being input can be determined before inputting the entire character string composed of the plurality of strokes.

Moreover, according to the above Embodiment 1, when inputting Japanese, hiragana or katakana, by comparing the sizes of the character currently being processed and the previously input character, whether or not the character currently being processed is a lower case character can be determined in the case the character currently being processed is smaller than the previously input character and the difference therebetween exceeds a prescribed threshold value. With this manner, lower case characters can be input in a natural manner of input without having to use a dedicated lower case key or input method.

Furthermore, although the case of the touch-type input device 2 and the display device 3 being separately provided devices is indicated in the above Embodiment 1, a configuration may also be employed in which the touch-type input device 2 is integrated with the display device 3 in the manner of a touch panel. In addition, an example of a touch-type input device 2 composed separately from the display device 3 is a pointing device of the display device 3 in the manner of an input pad installed on a PC or remote controller.

### Embodiment 2

Although the above-mentioned Embodiment 1 indicated the case of the pattern recognition processing device 4 detecting a corresponding partial touch area by making reference to partial touch area definition data, in Embodiment 2, pattern recognition processing is carried out by calculating the distance to each partial touch area without detecting a partial touch area per se. As a result of carrying out such processing, an input character can be detected and recognition accuracy can be improved over that of the prior art even in cases in which the starting point of a handwritten input is not precisely within a partial touch area.

Although the input device according to Embodiment 2 basically has the same configuration explained with reference to FIG. 1 in the above Embodiment 1, it differs from that of Embodiment 1 in that the pattern recognition processing unit carries out pattern recognition by detecting distances to each partial touch area instead of detecting a partial touch area per se. Thus, in the following explanation, FIG. 1 is referred to with respect to the configuration of the input device according to Embodiment 2.

Next, an operation thereof will be described.

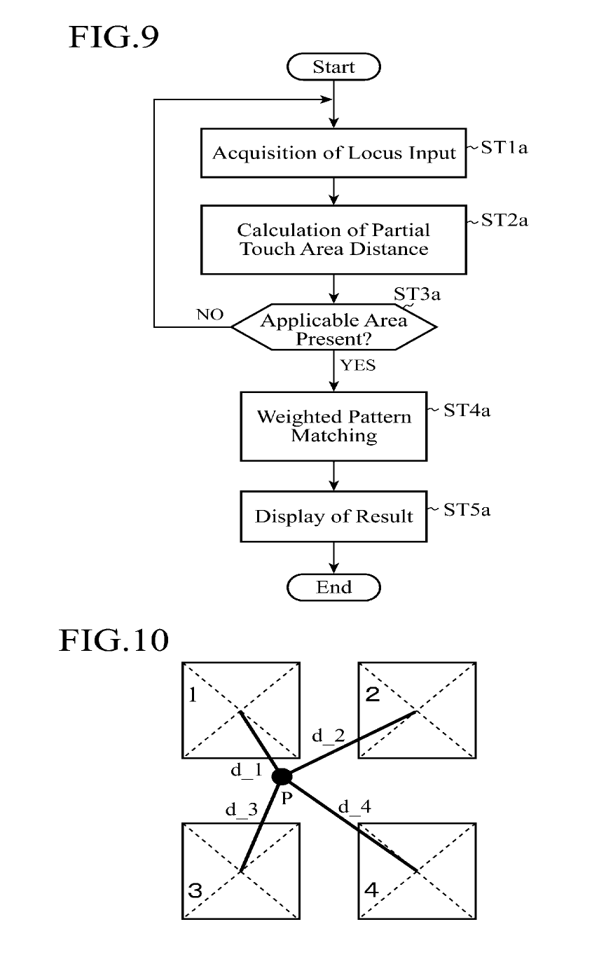

FIG. 9 is a flow chart showing the flow of operation by a pattern recognition processing unit according to Embodiment 2 of the present invention.

First, a user carries out handwritten input by a touch operation on the touch input area 2a of the touch-type input device 2. Locus data resulting from the handwritten input is acquired by the touch-type input device 2 and transferred to the pattern recognition processing unit 4 as locus input.

In the pattern recognition processing unit 4, when a locus input has been acquired from the touch-type input device 2 (Step ST1a), reference is made to partial touch area definition data of the storage unit 6, and the respective distances between the position coordinates of the input starting point of the input locus and all partial touch areas defined by the partial touch area definition data stored in the storage unit 6 are calculated (Step ST2a). The shortest distance from the position coordinates of the input starting point of the input locus to a rectangle indicating the partial touch area defined by the above-mentioned formula (1), or the distance to the central coordinates of the rectangle, for example, is used for the distance to the partial touch area. Hereupon, the number of partial touch areas is assumed to be N, and the distance string according to each distance of the partial touch areas 1 to N is assumed to be <r_1, r_N>.

Subsequently, the pattern recognition processing unit 4 compares each of the distances r_1 to r_N of the partial touch areas 1 to N with a prescribed threshold value, and determines whether or not a partial touch area has a distance equal to or less than the threshold value (Step ST3a). In the case where there are no distances to each of the partial touch areas that are equal to or less than the threshold value (all distances exceed the threshold value) (NO in Step ST3a), the pattern recognition processing unit 4 returns to the processing of Step ST1a, a locus is input, and repeats the processing from Step ST1a to Step ST3a until partial touch area appears for which the distance between the partial touch area and the position coordinates of the input starting point of the locus is equal to or less than the threshold value.

On the other hand, in the case where there is a partial touch area for which the distance is equal to or less than the threshold value (YES in Step ST3a), the pattern recognition processing unit 4 references the corresponding partial touch area/input feature pattern correspondence data from the storage unit 5 based on the partial touch area, and carries out weighting on each partial touch area. For example, in the case the distance between a partial touch area and an input locus is assumed to be r_a, the weight Wa of the partial touch area with respect to the distance r_a is given by Wa=1−(r_a/(r_1+r_2+, . . . , +r_N)). However, all of the distances r_1 to r_N are assumed to be equal to or less than the above-mentioned threshold value.

Thereafter, the pattern recognition processing unit 4 selects partial touch areas in order starting with that closest to the input locus according to the weighting values relating to the distances to the partial touch areas, searches the storage unit 5 based on the selected partial touch areas, references the corresponding partial touch area/input feature pattern correspondence data, and executes pattern matching between patterns registered in the data and the input locus acquired in Step ST1a (Step ST4a). The pattern candidate determined to be the recognition result by the pattern recognition processing unit 4 in the pattern matching is output to the display device 3. As a result, the pattern of the recognition result is displayed on the display screen of the display device 3 (Step ST5a).

An explanation of a specific example will now be given of weighting.

As shown in FIG. 10, there are four area numbered 1 to 4 serving as partial touch areas, and in the case the starting point is assumed to be P, and the distances from point P to the center of each area 1 to 4 are assumed to be d_1, d_2, d_3 and d_4, then weighting of each area 1 to 4 is defined in the manner indicated below. Thus, the value of the weighting can be increased in the shorter distance:

weighting of area 1: 1-d_1/D

weighting of area 2: 1-d_2/D

weighting of area 3: 1-d_3/D

weighting of area 4: 1-d_4/D,

provided that D=d_1+d_2+d_3+d_4.

The result of integrating the weighting with each score for which distance is not considered is used as an evaluation value.

As described above, according to Embodiment 2, pattern recognition processing is carried out by calculating the distances from a handwritten input locus to each partial touch area, and selecting the partial touch area closest to the locus according to the distance. With this manner, a partial touch area can be specified and characters can be recognized based on the distance from the approximately location of an input starting point even in the case a handwritten input starting point is precisely within a partial touch area. In addition, by selecting a partial touch area based on weighting corresponding to the corresponding distance, the number of character recognition targets can be narrowed down and recognition speed can be improved.

### Embodiment 3

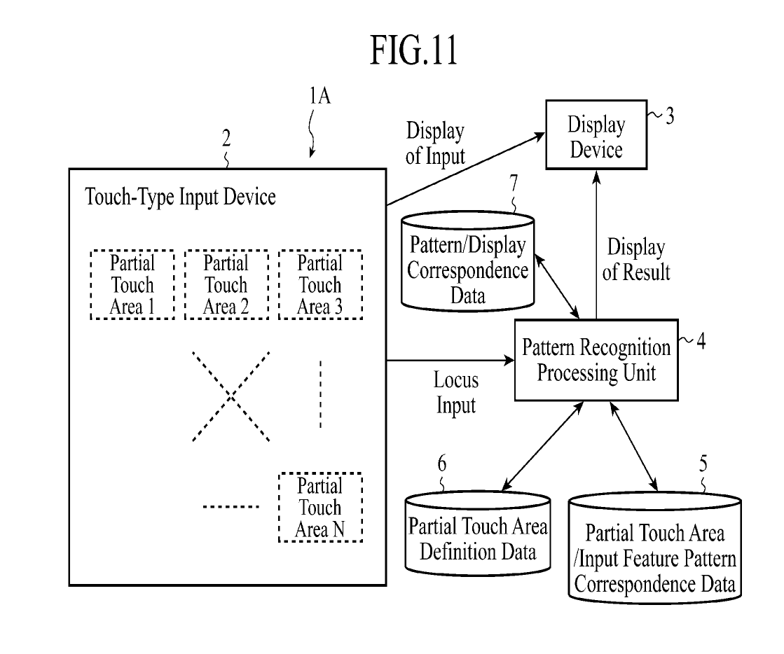

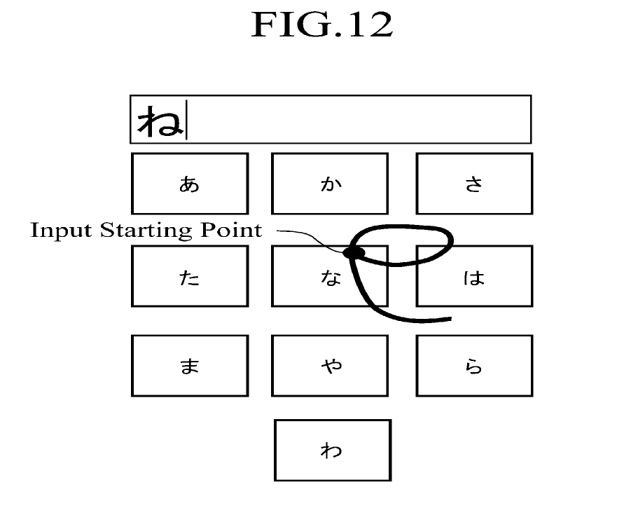

FIG. 11 is a block diagram showing the configuration of an input device according to Embodiment 3 of this invention. An input device 1A according to Embodiment 3 has a storage unit 7 that stores pattern/display corresponding data added to the configuration explained using FIG. 1 of the above-mentioned Embodiment 1. The pattern recognition processing unit 4 is able to display a display character “ [symbol] ” (ne) corresponding to a partial touch area on the display device 3 by referencing pattern/display correspondence data read from the storage unit 7 based on the detected partial touch area (for example, the “ [symbol] ” (na) button of FIG. 12 to be subsequently described) and an input feature pattern (such as pattern “e” of FIG. 12 to be subsequently described).

The pattern/display correspondence data consists of, for example, the following data.

< [symbol] (a): [symbol] (a), [symbol] (i), [symbol] (u), [symbol] (e), [symbol] (o)>

< [symbol] (ka): [symbol] (ka), [symbol] (ki), [symbol] (ku), [symbol] (ke), [symbol] (ko)>

< [symbol] (sa): [symbol] (sa), [symbol] (shi), [symbol] (su), [symbol] (se) [symbol] (so)>

< [symbol] (ta): [symbol] (ta), [symbol] (chi), [symbol] (tsu), [symbol] (te), [symbol] (to)>

< [symbol] (na): [symbol] (na) [symbol] (ni), [symbol] (nu), [symbol] (ne), [symbol] (no)>

< [symbol] (wa): [symbol] (wa), null, null, null, [symbol] (wo)>

Hereupon, those characters listed in the column to the left of the colon between the parentheses (< >) (the first sounds of consonants of the Japanese syllabary consisting of “ [symbol] ” (a), “ [symbol] ” (ka), “ [symbol] ” (sa), . . . “ [symbol] ” (wa)) indicate those characters displayed on the buttons, while those characters sequentially listed in the columns to the right of the colon indicate characters that are combinations of the above-mentioned characters displayed on the buttons and each of the pattern candidates “a”, “i” “u”, “e” and “o” corresponding to vowel phonemic symbols. Additionally, the term “null” indicates the absence of an applicable character.

FIG. 12 is a drawing showing an application example of an input device according to Embodiment 3, and indicates the case of applying this invention to a touch panel on which 10 buttons are arranged containing the first sounds of consonants of the Japanese syllabary consisting of “ [symbol] ” (a), “ [symbol] ” (ka), “ [symbol] ” (sa), “ [symbol] ” (ta), “ [symbol] ” (na), “ [symbol] ” (ha), “ [symbol] ” (ma), “ [symbol] ” (ya), “ [symbol] ” (ra) and “ [symbol] ” (wa). In this Embodiment 3, as shown in FIG. 12, partial touch areas that respectively distinguish the first sounds of consonants of the Japanese syllabary consisting of “ [symbol] ” (a), “ [symbol] ” (ka), “ [symbol] ” (sa), “ [symbol] ” (ta), “ [symbol] ” (na), “ [symbol] ” (ha), “ [symbol] ” (ma), “ [symbol] ” (ya), “ [symbol] ” (ra) and “ [symbol] ” (wa) are defined in partial touch area definition data.

In addition, five patterns consisting of “a”, “i” “u”, “e” and “o” corresponding to Japanese vowel phonemic symbols are registered in the partial touch area/input feature pattern correspondence data as common pattern candidates in each partial touch area.

During handwritten input of a Japanese character, a user starts the input from a button (partial touch area) and inputs a vowel phonemic symbol by handwritten input that becomes a desired character when combined with the consonant displayed on the button. The pattern recognition processing unit 4 references the partial touch area/input feature pattern correspondence data corresponding to the partial touch area where input was started, and executes pattern matching between the pattern candidates “a”, “i” “u”, “e” and “o” and the locus of the handwritten input locus.

When any of the patterns “a”, “i” “u”, “e” or “o” has been determined by pattern matching, the pattern recognition processing unit 4 references the pattern/display correspondence data of the storage unit 7, specifies a character resulting from combining the consonant displayed on the button corresponding to the partial touch area where input was started with the pattern candidate of the phonemic symbol, and outputs the specified character to the display unit 3 as the recognition result. In the example shown in FIG. 12, input is started from the button on which the consonant “ [symbol] ” (na) is displayed, and the pattern candidate “e” is then recognized by inputting the vowel phonemic symbol “e”. In this case, the character “ [symbol] ” (ne), resulting from combining the consonant “ [symbol] ” (na) with the vowel “e”, is displayed as the recognition result.

As has been described above, according to Embodiment 3, by displaying consonants in partial touch areas using only characters indicating the phonemic symbols of five vowels consisting of “a”, “i” “u”, “e” and “o” as character recognition targets of each partial touch area, a desired character is input by combining the consonant determined according to the starting location of handwritten input and a phonemic symbol of a vowel for which the pattern thereof has been recognized in handwritten input.

In this manner, the number of character recognition targets can be narrowed down and recognition speed can be improved by using only “a”, “i” “u”, “e” or “o” as character recognition targets of each partial touch area.

In addition, it is not necessary to perform the bothersome operation that presses the same button a plurality of times and search through a list of character candidates in order to input Japanese like conventional cell phones. Moreover, since only the character serving as a consonant is required to be input by handwritten input, Japanese characters can be input using fewer strokes than in the case of ordinary handwritten input of hiragana.

In addition, a configuration can also be employed in which letters of the alphabet corresponding to consonants in the manner of “A, “K”, “S”, . . . “W” as shown in FIG. 15 are displayed instead of the “ [symbol] ” (a), “ [symbol] ” (ka), . . . “ [symbol] ” (wa) shown in FIG. 12.

### Embodiment 4

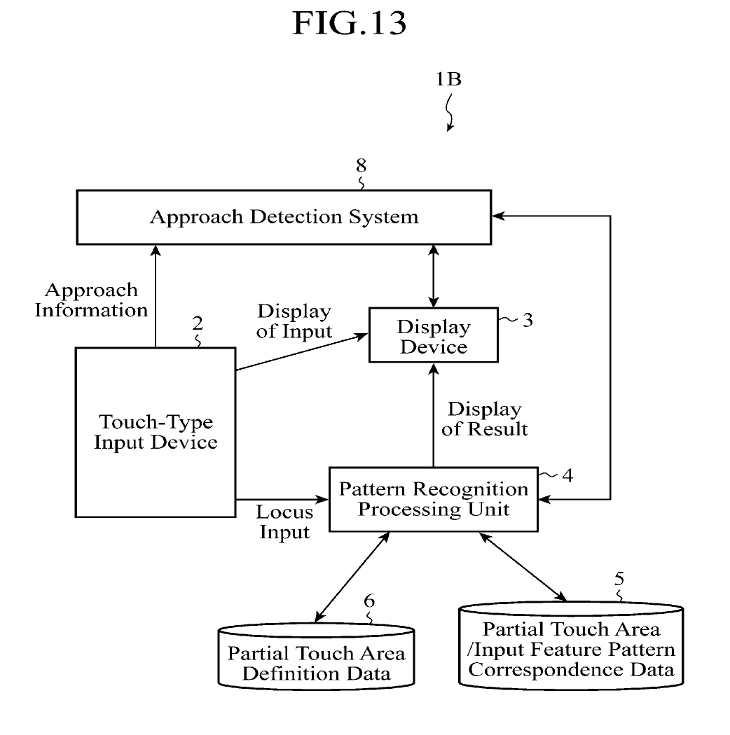

FIG. 13 is a block diagram showing the configuration of an input device according to Embodiment 4 of the invention. In FIG. 13, an input device 1B according to Embodiment 4 is provided with an approach detection system (approach detection unit) 8 in addition to the configuration explained using FIG. 1 in the above-mentioned Embodiment 1. The approach detection system 8 is a system that measures the distance between an object such as a hand or pen that is operated to carry out an input to the touch-type input device 2 and a touch input area of the touch-type input device 2. For example, the touch-type input device 2 is configured with an electrostatic touch panel that detects an approach of an object based on a change in electrostatic capacitance, and the distance between the object and a touch input area is measured based on approach information of the object detected by the electrostatic touch panel.

Next, an operation thereof will be described.

The approach detection system 8 measures the distance between an object such as a hand or pen and a touch input area based on object approach information acquired with the touch-type input device 2 as previously described, and if the distance is less than a prescribed threshold value, alters display data of the touch input area so as to generate an enlarged display of one or more partial touch areas in proximity to the area approached by the object in the touch input area, and displays the partial touch area(s) on the display device 3. At this time, the approach detection system 8 stores the relationship of the relative display locations before and after enlargement in display data of the touch input area.

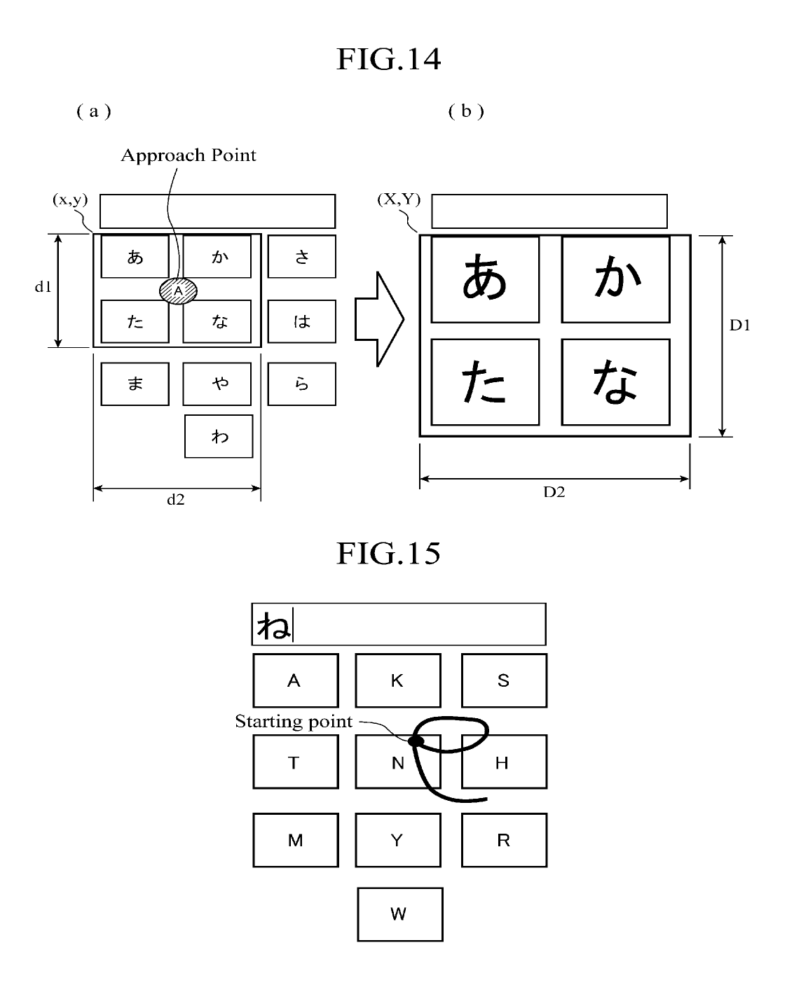

For example, in the case of FIG. 14 to be subsequently described, a configuration is employed so that the contents of changes in the number of partial touch areas are stored in the approach detection system 8 so as to change from the initial value of 10 to the value of 4 after enlargement, and an enlarged display is generated for the four partial touch areas in proximity to an approach point A.

Subsequently, the approach detection system 8 sequentially receives object approach information from the touch-type input device 2, measures the distances between the object and the touch input areas, and compares the distances with the above-mentioned threshold value. Here, if the object has moved away to a distance that exceeds the threshold value without a touch input to a touch input area being detected by the touch-type input device 2, the approach detection system 8 clears the stored relative display locations, and proceeds to wait for new object approach information from the touch-type input device 2.

On the other hand, if a touch input by the object to a touch input area is detected by the touch-type input device 2, the approach detection system 8 outputs the relationship between the relative display locations before and after enlargement to the pattern recognition processing unit 4. The pattern recognition processing unit 4 stores the relationship between the relative display positions before and after enlargement input from the approach detection system 8, and uses this relationship to initiate pattern recognition processing of the input locus. In this point, in the case where the distance between the object and a touch input area has exceeded the threshold value before notification of completion of locus recognition from the pattern recognition processing unit 4 (prior to completion of pattern recognition), the approach detection system 8 notifies the pattern recognition processing unit 4 of the distance having exceeded the threshold value.

If the pattern recognition processing unit 4 is notified that the object has moved away to a distance that exceeds the threshold value prior to completion of pattern recognition of the locus generated by the object, the pattern recognition processing unit 4 clears the above-mentioned relative location information input from the approach detection system 8. The pattern recognition processing unit 4 then proceeds to wait for a touch input.

In addition, if the distance between the object and a touch input area is equal to or less than the threshold value, the pattern recognition processing unit 4 carries out input character recognition in the same manner as the above-mentioned Embodiment 1 by searching for the partial touch area where input was started using the relative location information input from the approach detection unit 8 and location information of the locus defined by the object from the touch-type input device 2.

The following provides a detailed explanation of enlarged display processing of a partial touch area carried out by the approach detection system 8.

FIG. 14 is a drawing for explaining processing by which an enlarged display is generated for a partial touch area in proximity to an area approached by an object, with FIG. 14(a) indicating the touch input area before enlarging and FIG. 14(b) indicating the touch input area after enlarging. Here, the approach point A in FIG. 14(a) is defined to be the point approached by the object. In this case, when the vertical and horizontal dimensions of a rectangular area circumscribing each of the partial touch areas of buttons “ [symbol] ” (a), “ [symbol] ” (ka), “ [symbol] ” (ta) and “ [symbol] ” (na) in the vicinity of the approach point A are designated as d1 and d2, and the vertical and horizontal dimensions when a rectangular area has been enlarged are defined as D1 and D2, then the corresponding location within the rectangular area prior to generating the enlarged display can be calculated from the location (a, b) within the rectangular area of the enlarged display by using the following formula (2).

$$( X - x + \frac{aD 2}{d 2} , Y - y + \frac{bD 1}{d 1} ) \qquad ( 2 )$$

As described above, according to Embodiment 4, by detecting the approach of an input object such as a hand or pen towards a touch input area and generating an enlarged display of a partial display area in proximity to the approach point of the detected object, handwritten characters or gestures are recognized from pattern candidates set for the (enlarged) partial display areas and the input pattern. With this manner, the effects of unsteady input (hands movement) and the like can be reduced in devices having a confined input area or display area, thereby enabling reliable and high-speed character recognition.

### INDUSTRIAL APPLICABILITY

Since the input device of the present invention enables to enhance the recognition rate and recognition speed of handwritten character recognition, it is suitable for use in, for example, an interface that uses a touch operation for character input.

1. An input device, comprising:
a touch-type input unit that inputs a locus obtained by touching a touch input area;
a display unit that displays an input screen corresponding to the touch input area of the touch-type input unit;
a first storage unit that stores partial area definition data that defines a partial area of the touch input area of the touch-type input unit corresponding to an input button displayed on the input screen of the display unit as a location on the touch input area;
a second storage unit that stores correspondence data in which a plurality of different pattern candidates targeted for pattern recognition selected according to display contents of the input button are registered by associating with a partial area corresponding to the input button; and
a recognition processing unit that makes reference to the partial area definition data of the first storage unit to specify a partial area containing an input starting location of the locus input to the touch input area of the touch-type input unit, makes reference to the correspondence data of the second storage unit to acquire pattern candidates associated with the specified partial area, and recognizes a pattern corresponding to the locus using the acquired pattern candidates.

2. The input device according to claim 1, wherein in the case where there is no partial area containing the input starting location of the locus obtained by touching the touch input area, the recognition processing unit acquires pattern candidates associated with a partial area in which a distance from the input starting location to the partial area is equal to or less than a prescribed threshold value, and recognizes a pattern corresponding to the locus by using the acquired pattern candidates.

3. The input device according to claim 1, wherein the second storage unit stores, as the correspondence data, pattern candidates of a character displayed on the input button and a character relating thereto, and
each time a stroke that composes the character is input by touching the touch input area, the recognition processing unit acquires the pattern candidates corresponding to a locus of the stroke by referencing the correspondence data of the second storage unit, and recognizes a pattern corresponding to the locus using the acquired pattern candidates.

4. The input device according to claim 1, wherein the second storage unit stores, as the correspondence data, pattern candidates of a hiragana character and a katakana character displayed on the input button, and the recognition processing unit compares a locus for which a pattern has been previously recognized with a currently input locus in the size on the touch input area, and in the case where the size of the currently input locus is smaller, makes reference to the correspondence data of the second storage unit to acquire pattern candidates corresponding to the currently input locus from lower case pattern candidates of the hiragana character or the katakana character, and recognizes a pattern corresponding to the locus by using the acquired pattern candidates.

5. The input device according to claim 1, wherein first sounds of consonants of the Japanese syllabary are respectively displayed on input buttons,
the second storage unit stores, as the correspondence data, only pattern candidates of phonemic symbols “a”, “i”, “u”, “e” and “o” indicating Japanese vowels by associating with partial areas corresponding to input buttons, and
the recognition processing unit makes reference to the partial area definition data of the first storage unit to specify a partial area containing the input starting location of the locus input to the touch input area of the touch-type input unit, and makes reference to the correspondence data of the second storage unit to acquire pattern candidates associated with the specified partial area, and upon specifying a pattern candidate corresponding to the locus obtained by touching the touch input area using the acquired pattern candidates, the recognition processing unit determines, as a recognition result, a character resulting from combining the character of the first sound of the consonant displayed on the input button and the phonemic symbol indicating a Japanese vowel of the specified pattern candidate.

6. The input device according to claim 1, further comprising an approach detection unit that detects an object that approaches a touch input area, wherein the display unit generates an enlarged display of the input button corresponding to a partial area in the vicinity of a location, on the touch input area, approached by the objected detected by the approach detection unit.
